(19) United States
(12) Patent Application Publication
(10) Pub. No.: US 2015/0122824 A1
(43) Pub. Date: May 7, 2015

(54) Plate Having Integrated Cup Holder

(71) Applicant: Leandro Margulis, San Francisco, CA (US)

(72) Inventor: Leandro Margulis, San Francisco, CA (US)

(21) Appl. No.: 14/069,591

(22) Filed: Nov. 1, 2013

(51) Int. Cl. A47G 19/02; B29C 67/00

(52) U.S. Cl. CPC A47G 19/065; B29C 67/0051; B29L 2031/737
USPC 220/575; 220/574; 264/308

(57) ABSTRACT

The present disclosure provides a plate including a base portion, and a cup holder located substantially towards a center of the base portion. The cup holder has a top portion that extends above the base portion and a bottom portion that extends below the base portion. An outer rim is located along a circumference of the base portion and extends above the base portion to a height substantially similar to that of the upper portion of the cup holder. The cup holder can have a seat in the bottom portion that can be located at a bottom most portion of the bottom portion or at a distance away from the bottom most portion of the bottom portion.

### FIELD OF THE DISCLOSURE

The present disclosure relates generally to a dinner plate having an integrated cup holder and, more specifically, to an exemplary dinner plate having an integrated cup holder that is easily grasped, and is stackable.

### BACKGROUND INFORMATION

A common problem encountered at social gatherings, such as picnics, parties, and receptions where food is served while the guests are standing, is the difficulty of holding both a plate of food and a beverage, while at the same time keeping a hand free with which to eat. Often, diners will resort to setting down their beverage on any nearby surface (e.g., a table), or will awkwardly try to hold both their plate and cup in the same hand. Many combination plate and cup holders have been designed seeking to address this problem. The basic goals that designers have attempted to meet are the need for an easily-held plate that securely retains a cup or beverage can, but which is not top heavy, can be sat on a flat surface if desired, and is inexpensive to manufacture and ship. However, existing designs all fail to meet at least one of these goals.

U.S. Pat. No. 5,441,164 to Beck et al. (“Beck”), discloses a plate and cup holder where the center of gravity of the combined plate and cup holder is lowered by providing a cutout in the central cup holder for the handle of a cup, which allows a coffee cup, or other cup having a handle, to sit deeper in the cup holder, and therefore closer to the plate. Beck, however, does not address the problem of making the plate itself easier to hold.

Other plates have followed different approaches in seeking to develop an easily held combination plate and cup holder. U.S. Pat. No. 2,240,020 to Raiser (“Raiser”), from 1937, illustrates a combined plate and cup holder in which the cup holder extends below the plate, giving the diner a more convenient and stable means of holding the plate. The Raiser design, while stackable, requires a separate spacer element in the cup holder to be removed before stacking. While the plate in Raiser is more convenient for a standing diner, the plate cannot stably rest on a flat surface, particularly if loaded with food.

U.S. Pat. No. 5,292,028 to Patterson, et al. (“Patterson”) discloses a similar concept to Raiser in which a common beverage can may be attached to the bottom of a plate. Thus, the beverage can serve as a means of holding both the can and the plate. Patterson, however, requires that the diner drink through a straw, and has stability problems, similar to those of the plate in Raiser, when rested on a flat surface.

A different approach is disclosed by U.S. Pat. No. 4,461,396 to Harper (“Harper”), in which a hole is provided in the plate, allowing the combined plate and glass holder to be grasped like an artist's palette, with the diner's thumb placed through the hole while the rest of the diner's hand is placed beneath the plate. The diner's thumb can rest on the base of a stemware glass placed in the shallow cup holder, providing a tenuous support for the glass. A similar design is used in U.S. Design Pat. No. 366,817 to Sampson (“Sampson”), which physically resembles an artist's palette, and incorporates a second hole into which a tapered cup may be placed.

Thus, it may be beneficial to provide an exemplary plate having an integrated cup holder, that can be grasped with one hand, is stable on a flat surface, can be nested or stacked together, and which can overcome at least some of the deficiencies described herein above.

### SUMMARY OF EXEMPLARY EMBODIMENTS

The present disclosure provides a plate having an integrated cup holder for holding a drink or a cup. The exemplary plate can be easily held with one hand, allowing the free hand of a person to interact with the food on the plate, the drink in the integrated cup holder, or with another person. The exemplary plate is also stable enough to be placed on a table without leaning, tipping, or falling over.

In addition to providing a secure means to hold a cup or beverage can/bottle and being easy to hold, the exemplary plate can be simple to manufacture. Complex design consisting of an assemblage of separate parts, or having complex shapes, may be prohibitively expensive to manufacture. In many social situations it is desirable that the plates, cups, and dinnerware used by guests be disposable, both to save the cost of cleanup, and because the social event may be a one-time event, and no reuse of the items is contemplated. Thus, the exemplary plate can be affordable to the consumer as a disposable item, can be simple to manufacture, and can nest together compactly for shipping, storage, and sale.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a top down view of an exemplary plate according to an exemplary embodiment of the present disclosure;

FIG. 2 is perspective view of the plate from FIG. 1 according to an exemplary embodiment of the present disclosure;

FIG. 3 is a cross-sectional view of the plate from FIG. 1 according to an exemplary embodiment of the present disclosure;

FIG. 4 is a cross-sectional view of two plates stacked together according to an exemplary embodiment of the present disclosure;

FIG. 5 is a perspective view of plate 100 having a tapered upper portion according to an exemplary embodiment of the present disclosure; and

FIG. 6 is a side view of two plates stacked together according to an exemplary embodiment of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION OF EXEMPLARY EMBODIMENTS

The present disclosure relates to a plate having a cup holder disposed within the plate, allowing a person to hold both their food and their drink in one hand. The person's second hand is then free to be used to eat food off the plate, grasp the cup to drink, or interact with other people (e.g., shake the hand of another person). The plate is also easy to manufacture, can be reused or disposed of after a single use, and is easily stacked or nested. The combined plate and cup holder incorporates an integrated cup holder, the bottom portion of which serves as a convenient way for the plate to be held by a person.

The exemplary plate can be manufactured as a single piece, which can stack or “nest” together in an efficient manner for shipping, storage, and sale, thus reducing the cost to the consumer. This can be achieved with a plate cross section which can be manufactured using simple manufacturing methods such as molding or stamping.

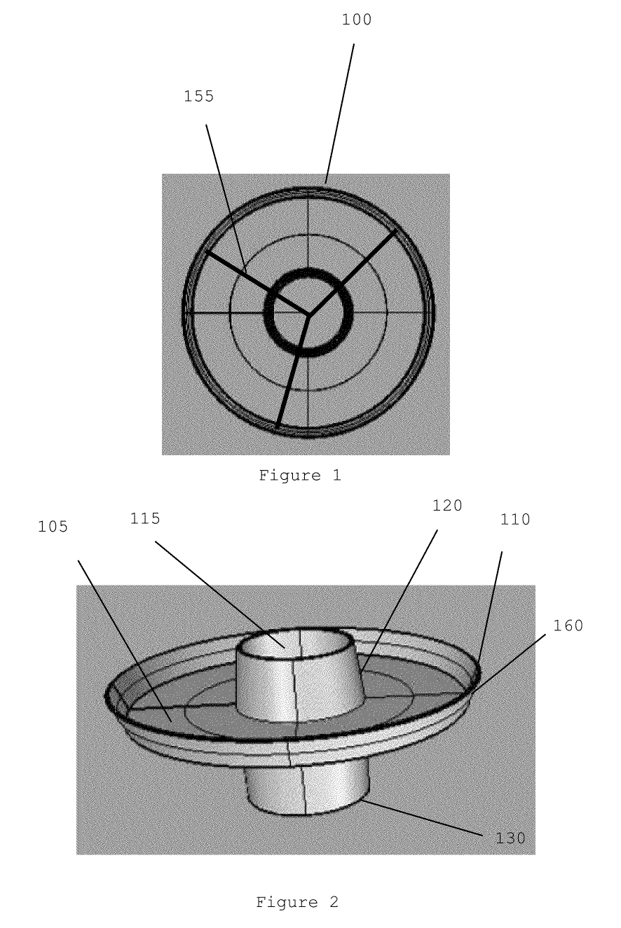

Referring to FIGS. 1-3, an exemplary plate 100 is shown. Plate 100 can be round, square, or of any suitable shape for use as a plate. Plate 100 can be a dinner plate (e.g., about 9-14 inches), and appetizer plate (e.g., 4-9 inches), or any other suitable plate that is sized large enough to integrally form a cup holder in the plate. Plate 100 can have a bottom or well 105 for placing and holding food on the plate, which can be substantially flat or rounded, similar to a standard plate. Plate 100 can have a lip 110 around the circumference of well 105 which can be used to hold food on well 105, and can aid in preventing any food from falling off of plate 100. Lip 110 can encompass all or a portion of well 105, and can be substantially perpendicular to well 105, or at an angle other than perpendicular to facilitate stacking or nesting with a further plate. As seen in FIG. 2, lip 110 is at an obtuse angle from well 105. The angle can be selected depending on the size of the plate, and the type of plate (e.g., appetizer plate, salad plate, dinner plate etc.). Additionally, the angle can be a positive angle to facilitate easy three-dimensional (“3D”) printing of plate 100.

Lip 110 can have a height 145 that extends above well 105. The height 145 of lip 110 can be selected depending on the size of the plate, and the type of plate (e.g., appetizer plate, salad plate, dinner plate etc.). Height 145 can facilitate easy stacking and nesting of a plurality of plates for storage and/or transport. Lip 110, having height 145, can also facilitate easy holding of any food on well 105, and can aid in ease of eating and cleanliness, as it can prevent both food and liquid from falling off of plate 100. It should be noted that lip 110 need not be present, and plate 100 can have a standard edge that does not extend above, or substantially above, well 105.

Plate 100 can have a cup holder 115 formed integrally within plate 100. Cup holder 115 can be located approximately in the center of plate 100 (in the center of well 105) to provide balance and stability to plate 100. Cup holder 115 can have an upper portion 120 which can be connected to well 105. Upper portion 120 can provide the boundary for any cup placed inside of cup holder 115, and can help securely hold a cup inside of cup holder 115. Upper portion 120 is preferably round (e.g., cylindrical) and can have a diameter that is chosen based on the type of drinks and cups to be served. For example, the diameter of upper portion 120 can be based on the diameter of a typical soda can, the diameter of a typical soda bottle, the diameter of a glass (e.g., a drinking glass or a wine glass), etc. Exemplary diameters for upper portion 120 can range from 2.5″-3.5″, although larger or smaller diameters can be used. The diameter of upper portion 120 can be uniform, or the diameter can vary either at an acute or an obtuse angle with respect to well 105.

Upper portion 120 can have the same or similar height to height 145 of lip 110, such that the overall height of plate 100 is uniform for any portion that extends above well 105. Alternatively, the height of upper portion 120 can be different from height 145 of lip 100 (e.g., either smaller or larger). The height of upper portion 120 can be chosen based on the overall height of cup holder 115, including any portion that extends below well 105 (detailed below), such that cup holder 115 can hold and maintain support of any cup or drink placed inside of cup holder 115.

Plate 100 can have one or more separators 155 for separating different kinds of foods, similar to plates or bowls for babies. Separator 155 can be of any suitable shape or size depending on the size of the plate, and the type of plate (e.g., appetizer plate, salad plate, dinner plate etc.). The height of separator 105 can be similar to the height 145 of lip 110. Separator 155 can be formed on top of well 105, extending from upper portion 120 to lip 110. Alternatively, to facilitate stacking, separator 155 can be formed integrally within well 105 such that separator 105 protrudes above well 105 creating a space under separator 105 for a further separator of a further plate to fit into.

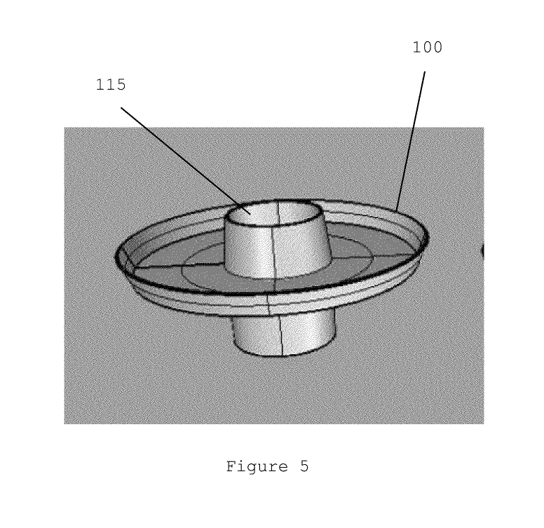

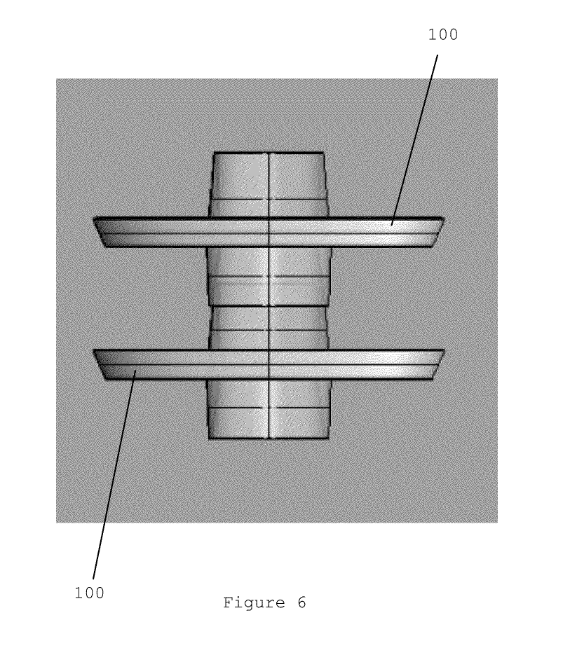

Cup holder 115 can have a lower portion 130, which extends below well 105. Exemplary ranges for lower portion 130 can be 2″-3″, although lower portion 130 can be larger or smaller. Lower portion 130 can be easily gripped by a person holding plate 100 such that the person can hold and support plate 100 with one hand, and use there free hand to interact with the food or beverage on plate 100, or with another person. Lower portion 130 can be cylindrical or substantially cylindrical, can have a uniform or non-uniform diameter, and can have a diameter that is the same or different from the diameter of upper portion 120. If the diameter of lower portion 130 is different from the diameter of upper portion 120, then multiple plates can be nested together. For example, if the diameter of lower portion 130 is less than the diameter of upper portion 120, or if the diameter of lower portion 130 is non-uniform and tapers, then multiple plates can be nested together by inserting the lower portion of one plate into the upper portion of another plate. (See e.g., FIG. 4). The diameter of lower portion 130 can depend on the size of the cup that plate 100 is to be used with, but is preferably large enough to provide a stable base when plate 100 is placed on a flat surface (e.g., a table). This allows plate 100 to function as both a stable, one-handed, plate to be held by a person, and also as a stable plate to be set on a table without rocking, tipping, or falling over. Alternatively, the diameter of upper portion 120 can taper (FIG. 5), and multiple plates can be nested together by inserting the upper portion of one plate into the lower portion of another plate. (See e.g., FIG. 6).

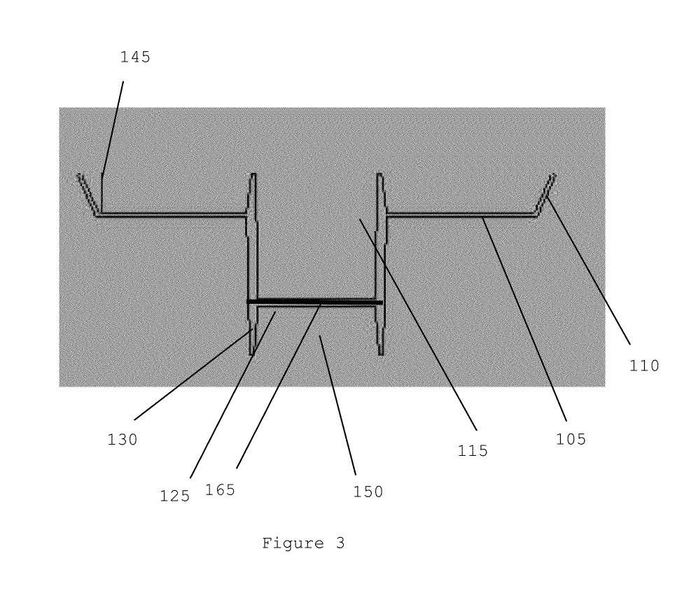

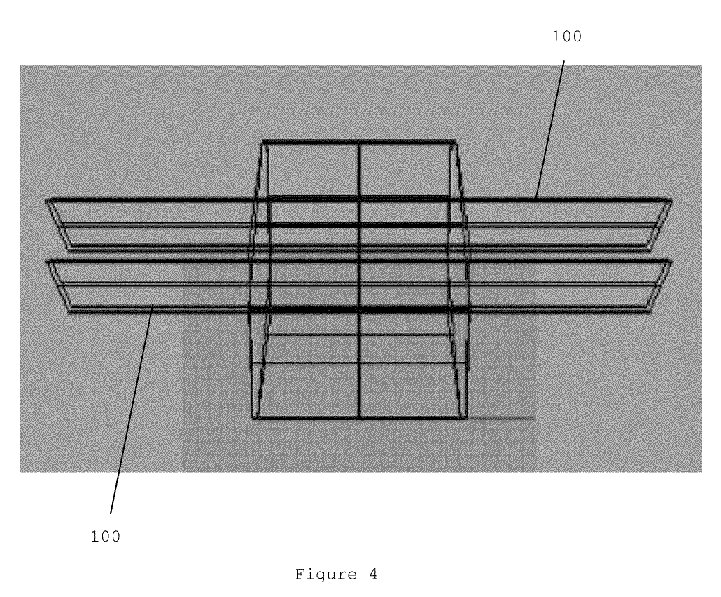

Cup holder 115 can have a bottom or seat 125, which can be integrally formed with lower portion 130. Bottom 125 can be sized to cover all or a portion of the area of lower portion 130. As shown in FIG. 3, bottom 125 can be located at a distance away from the bottom most portion of lower portion 130. This creates a space 150 between the bottom most portion of lower portion 130 and bottom 125. Space 150 can facilitate the insertion of some or all of the fingers of the person holding plate 100. Additionally, space 150 can facilitate enhanced stackability and nesting between multiple plates, as well as provide additionally stability in uneven surfaces. Further, space 150 can provide a more solid, reinforced design at the edges with additional material where it is needed the most, which is in contact with other surfaces, making plate 100 more durable. Alternatively, bottom 125 can be located at the bottom most portion of lower portion 130.

Plate 100 can be reusable or single use (e.g., disposable) and can be biodegradable. Multiple plates can be easily stacked together for packaging and transport. Plate 100 can be made of plastic that can be thermoformed, or 3D printed, Alternatively, plate 100 can be made from ceramic or other suitable material for making plates, for example, to be used at high-end events like weddings, receptions, etc. Plate 100 can have a rubber or silicone ring around well 105 (see e.g., element 160 of FIG. 2) or around lower portion 130 (see e.g., element 165 of FIG. 3), to facilitate an easier grip of plate 100, and to allow for more friction between lower portion 130 and any surface that plate 100 is set down on. Plate 100 can be easily held by one hand of a person while their other hand is free to interact with food, beverages or other people, and can also maintain stability when plate 100 is placed on a table.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A plate comprising:
a base portion;
a cup holder located substantially towards a center of the base portion, the cup holder having a top portion that extends above the base portion and a bottom portion that extends below the base portion; and
an outer rim located along a circumference of the base portion and extending above the base portion to a height substantially similar to that of the upper portion of the cup holder.

2. The plate of claim 1, further comprising a seat located in the bottom portion of the cup holder.

3. The plate of claim 2, wherein the seat is located at a bottom most portion of the bottom portion.

4. The plate of claim 2, wherein the seat is located at a distance away from the bottom most portion of the bottom portion.

5. The plate of claim 1, wherein a diameter of the bottom portion is less than a diameter of the top portion.

6. The plate of claim 1, wherein a diameter of the top portion is less than a diameter of the bottom portion.

7. The plate of claim 1, wherein the bottom portion tapers away from the base portion.

8. The plate of claim 1, wherein the top portion tapers away from the base portion.

9. The plate of claim 1, wherein the plate is of unitary construction.

10. The plate of claim 1, further comprising at least one separator extending from the top portion to the outer rim.

11. The plate of claim 10, wherein a height of the at least one separator is substantially similar to that of the upper portion.

12. The plate of claim 1, wherein an angle between the outer rim and the base portion is obtuse.

13. The plate of claim 1, further comprising a grip located on the bottom portion.

14. The plate of claim 13, wherein the grip is made from at least one of silicone or rubber.

15. The plate of claim 1, wherein the upper portion and the lower portion are cylindrical.

16. A plurality of plates, each plate comprising:
a base portion;
a cup holder located substantially towards a center of the base portion, the cup holder having a top portion that extends above the base portion and a bottom portion that extends below the base portion; and
an outer rim located along a circumference of the base portion and extending above the base portion to a height substantially similar to that of the upper portion of the cup holder.

17. The plurality of plates of claim 16, wherein the plurality of plates are nested together by inserting the bottom portion of one plate into the top portion of another plate.

18. The plurality of plates of claim 16, wherein the plurality of plates are nested together by inserting the top portion of one plate into the bottom portion of another plate.

19. A method for manufacturing a plate, comprising the step of:
printing, using a three-dimensional printer, at least one plate, the at least one plate comprising:
a base portion;
a cup holder located substantially towards a center of the base portion, the cup holder having a top portion that extends above the base portion and a bottom portion that extends below the base portion; and
an outer rim located along a circumference of the base portion and extending above the base portion to a height substantially similar to that of the upper portion of the cup holder.

20. The method of claim 19, further comprising the step of printing a further plate that is stackable with the at least one plate.
